(19) United States
(12) Patent Application Publication
(10) Pub. No.: US 2013/0254174 A1
(43) Pub. Date: Sep. 26, 2013

(54) METHOD AND RELATED APPARATUS FOR GENERATING ONLINE AND PRINTING ON-DEMAND COMPILATION OF WORKS WITH SHARING AND OWNERSHIP TRANSFER FEATURES

(71) Applicants: Daniel BARBER, Tustin, CA (US); David ASAO, Irvine, CA (US); Philip WU, Seal Beach, CA (US); Toshiro FUJIMORI, Laguna Beach, CA (US)

(72) Inventors: Daniel BARBER, Tustin, CA (US); David ASAO, Irvine, CA (US); Philip WU, Seal Beach, CA (US); Toshiro FUJIMORI, Laguna Beach, CA (US)

(73) Assignee: KONICA MINOLTA LABORATORY U.S.A., INC., San Mateo, CA (US)

(21) Appl. No.: 13/426,584

(22) Filed: Mar. 21, 2012

(51) Int. Cl. G06F 17/30

(52) U.S. Cl. 707/705; 707/E17.01; 707/E17.032

(57) ABSTRACT

A method and related apparatus for managing files for producing a compilation of works, comprising the steps of obtaining a file of a work to be compiled in a booklet by a first user, sharing the file or sharing or transferring part of whole of the booklet created by the first user with a second user, and selecting by the second user to accept or reject the sharing of the file or the sharing or transferring of the booklet by the first user.

### BACKGROUND OF THE INVENTION

1. Field of the Invention

This invention generally relates to a method and related apparatus for generating online and printing on-demand compilation of works, and in particular, it relates to managing contents and assembling articles into booklets with sharing and ownership transfer features.

2. Description of Related Art

The rapid development of new printing and telecommunication technologies has made it possible to generate and provide customized compilation of works in printed or other electronic forms on a print-on-demand (POD) basis, which generally refers to production of commercial-quality finished products in printed or electronic forms such as books and compilation booklets on a relatively small scale, typically by a professional print shop, at the request of customers.

One example of generating and producing compilations of works may be that in many educational institutions, a teacher or professor often needs to assemble a group of works and compile them into a volume of course materials. Another example may be that in a business entity or an organization, an instructor or trainer needs to assemble a group of works and compile them into a booklet of training materials. Such works may include previously published papers or articles, images and graphics etc. which may be available in hard copies traditionally but now increasingly in electronic (digital) formats, such as in the portable document (PDF) format.

These works may include PDF files in the teacher or instructor's own collection, e.g., stored in his or her own computer storage device such as a hard disc drive, or in a file folder assigned to him or her on a server of the institution or organization. These works may also include PDF files in other third parties' collections, e.g., stored in the third parties' servers and make be accessed via a computer network such as the Internet by using uniform resource locator (URL) links.

Once the teacher or instructor selects the PDF files, they can be assembled together to generate a compilation of works. After a compilation of works is generated into a volume or booklet of articles, students or organization members may purchase the volume or booklet by placing POD orders with a print shop that can print and deliver the volumes or booklets to the students or members.

During the process of creating a volume or booklet of articles, a teacher or instructor may come across an article that he or she believes that another teacher or instructor may be interested to use in the other teacher or instructor's volume or booklet, and therefore will like to share the article with that other teacher or instructor. Sometimes the teacher or instructor may have other people such as a teaching assistant to help him or her in preparation of a volume or booklet and after the volume or booklet is prepared, the teacher or instructor needs to have full control or capacity in revising, finishing and/or publishing the volume or booklet. There is a need to provide a more efficient and cost-effective method and related apparatus for online generation and purchase of compilations of works on a POD basis with the features for sharing the articles or booklets of a compilation of works and for assigning or transferring the control or ownership of the articles or booklets of a compilation of works.

### SUMMARY

The present invention is directed to a method and related apparatus for generating and printing compilations of works, which provides a more efficient and economical online platform for easily managing contents and assembling articles into booklets that can be readily ordered and printed on-demand, with sharing and ownership transfer features.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and/or other objects, as embodied and broadly described, the present invention provides a method for managing files for producing a compilation of works, comprising the steps of: obtaining a file of a work to be compiled in a booklet by a first user; sharing the file by the first user with a second user; and selecting by the second user to accept or reject the sharing of the file shared by the first user.

The exemplary embodiment of the present invention also provides a method for managing files for producing a compilation of works, comprising the steps of: creating a booklet by a first user that contains files of works to be compiled; sharing a part or whole of the booklet by the first user with a second user; and selecting by the second user to accept or reject the sharing of the booklet shared by the first user.

The exemplary embodiment of the present invention further provides a method for managing files for producing a compilation of works, comprising the steps of: creating a booklet by a first user that contains files of works to be compiled; transferring the booklet from the first user to a second user; and selecting by the second user to accept or reject the transfer of the booklet by the first user.

In another aspect, one exemplary embodiment of the present invention further provides a computer program product that causes a data processing apparatus to perform the above methods. The computer program product includes a computer usable non-transitory medium (e.g. memory or storage device) having a computer readable program code embedded therein for controlling a data processing apparatus, the computer readable program code configured to cause the data processing apparatus to execute the methods described above.

It is to be understood that both the foregoing general description and the following detailed description are exemplary and explanatory and are intended to provide further explanation of the invention as claimed.

### BRIEF DESCRIPTION OF THE DRAWINGS

FIG. 1 schematically illustrates an exemplary online environment in which embodiments of the present invention may be implemented.

FIG. 2 schematically illustrates an exemplary computer program architecture in which embodiments of the present invention may be implemented.

FIG. 3 schematically illustrates an exemplary process for online management of contents and generation of booklets as parts of a computer-implemented method for generating and printing compilations of works in accordance with an embodiment of the present invention.

FIGS. 4-12 illustrate screen shots from executing various steps of the exemplary process for online management of contents as shown in FIG. 3.

### DETAILED DESCRIPTION OF PREFERRED EMBODIMENTS

Embodiments of the present invention provide a more efficient and cost-effective method and related apparatus for online management, generation and purchase of compilations of works on a print-on-demand (POD) basis.

As an example of practical scenarios of the need for managing, generating and printing compilations of works, a teacher or professor in an educational institution may need to assemble educational materials for the students to order and purchase. As another example of practical scenarios of such need, an instructor or trainer of a business entity or organization may need to assemble training materials for the members to order and purchase.

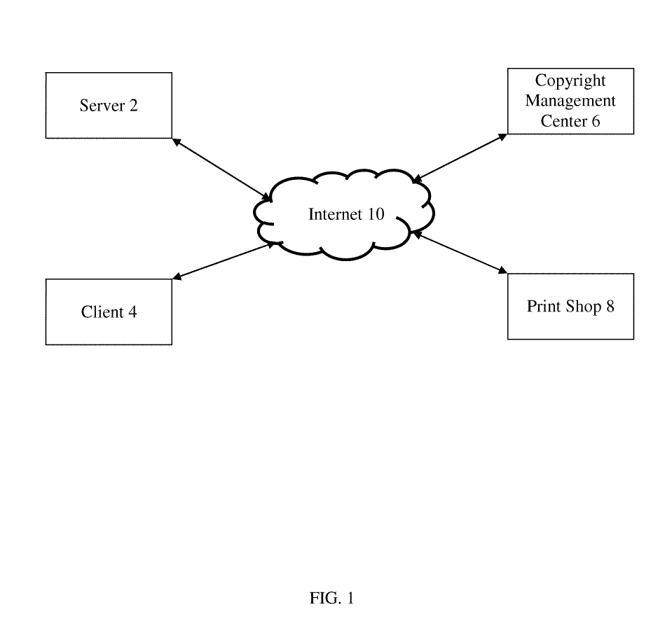

Referring to FIG. 1, there is schematically illustrated an exemplary online environment in which embodiments of the present invention may be implemented. The exemplary online environment includes a server 2, a client computer 4, one or more copyright management center servers 6, and a print shop server 8, connected via one or more computer network 10 such as the Internet or other communication links. A client (such as a teacher or a trainer, or a student or a member of an organization) uses the client computer 4 to interact with the server 2. The server 2 executes a computer program stored in a memory to perform processes according to the embodiments of the present invention. The copyright management center servers 6 stores digital contents and associated copyright data or license information that may be obtained for use by the clients. The print shop may be a professional print shop equipped with printers and various other image reproduction machines for producing printed products such as books, booklets, etc. The print shop server 8 manages the print jobs submitted to the print shop by the clients or customers.

The server 2 generally provides an integrated service that allows a client to search and acquire contents from content sources, to compile them into an electronic file and submit the compiled file to a POD service to produce a printed product, and to order and purchase the printed product of the compiled works. The clients may access the server 2 from their own computers 4 via the network 10 once they establish their user accounts on the server 2. The server 2 may interact with the copyright management center server 6 for searching and obtaining contents of the works to be compiled. The server 2 may also interact with the print shop server 8 for printing and delivering the compiled works in hard copy or electronic forms.

In this application, the term “copyright management center” generally refers to a place or service that facilitates the management and distribution of copyrighted materials and the obtaining and transferring of payment to copyright holders. Typically, a copyright management center facilitates legitimate access to copyrighted content by providing a copyright registry, where users can locate copyright information about a work, by also providing a copyright marketplace exchange, where users can buy and sell copyrights, and by further providing a copyright clearance service that can connect with third party distribution platforms. Examples of such copyright management centers may include digital repository of published work maintained by some publishers or digital libraries maintained by various organizations. Another example of copyright management center is the Copyright Clearance Center.

Therefore, “copyright management center 6” of the online environment shown in FIG. 1 may include any types of sources of digital contents and their copyright data and license information. More generally, “copyright management center 6” of the online environment shown in FIG. 1 may also include any third party content sources such as databases or depositories where hard or electronic copies of articles, publications or other contents and works may be stored or otherwise kept.

The physical locations or the commercial relationship among the various components of the online environment shown in FIG. 1 are not important. For example, the server 2 may be operated by the copyright management center, or the print shop, or a separate institution, organization or commercial establishment.

Also in this application the term “client” generally refers to a customer or anyone who uses the method or related apparatus provided by the embodiments of the present invention. For example it may refer to a teacher or student in an educational institute, or an instructor or a member in an organization. Specifically for the process described in this application, “client” may refer to “booklet compiler” and “booklet reader”, where “booklet compiler” (or “compiler”) refers to anyone who manages the contents or articles, and generates compilation of works from the contents or articles, and “booklet reader” (or “reader”) refers to anyone who orders the printing or purchases the finished product of the compilation of works that have already been generated. For example, a compiler may be a teacher in an educational institute or an instructor of an organization, whereas a reader may be a student in the educational institute or a member of the organization.

Both the compilers and the readers may have access accounts at the server 2 and share some common rights or features on the server 2, but some of their other rights may be different. For example, a compiler may have right to generate a booklet from compilation of works, whereas a reader may not have such right but may have right to order prints of the booklet. These details will become more apparent and clear in the description below.

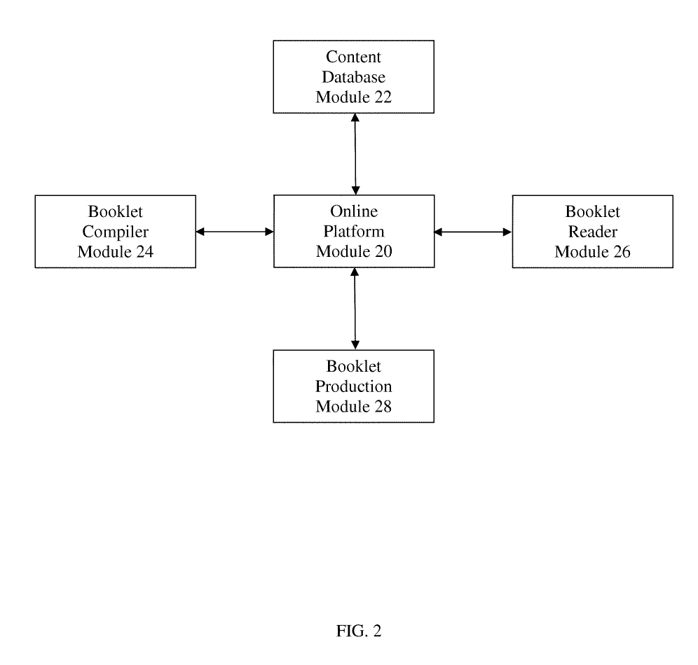

As mentioned earlier, in one aspect the present invention is embodied a computer program product that causes a data processing apparatus to perform the methods of the present invention. The computer program product includes a computer usable non-transitory medium (e.g. memory or storage device) having a computer readable program code embedded therein for controlling a data processing apparatus, where the computer readable program code is configured to cause the data processing apparatus to execute the method of the present invention. The computer readable program code includes many functional modules and the essential ones that are closely related to the steps of the process described below are exemplarily shown in FIG. 2.

Referring to FIG. 2, there is schematically shown an exemplary computer program architecture in which embodiments of the present invention may be implemented. The computer program architecture shown in FIG. 2 includes functional modules that are essential and closely related to the steps of the process according to the present invention.

More specifically, there is shown an online platform module 20 that controls and executes the operations at the server 2 (and/or the print shop server 8) shown in FIG. 1 for providing an online platform to implement the relevant steps of the present invention process, including but not limited to, providing a user interface (UI) to the clients, providing clients account and access management on the server 2, providing folder structure and data storage management to the clients on the server 2, and providing online ordering and payment capacities on the server 2, etc.

There is also shown in FIG. 2 a booklet compiler module 24 that controls and executes the operations at the customer's computer 4 or server 2 (and/or the server at copyright management center 6) shown in FIG. 1 for providing access to server 2 by a compiler, managing the compiler's account information at the server 2, managing the file folders assigned to the compiler, creating and editing booklets, ordering booklets and paying online, etc.

There is further shown in FIG. 2 a booklet reader module 26 that controls and executes the operations at the customer's computer 4 or server 2 (and/or the server at copyright management center 6) shown in FIG. 1 for providing access to server 2 by a reader, managing the reader's account information at the server 2, browsing and searching for booklets, ordering booklets and paying online, etc.

In addition, there is shown in FIG. 2 a booklet production module 28 that controls and executes the operations at the server 2 (and/or the server at print shop 8) shown in FIG. 1 for processing print orders made at the online platform 20, processing payment for purchases of booklets, making print job orders, transmitting electronic files of the booklets to the print shop server 8, and handling production, assembly and delivery of booklets, etc.

It is understood that the exemplary computer program architecture in which embodiments of the present invention may be implemented may include other functional modules not shown in FIG. 2 that facilitates the execution of the steps of the process in accordance with the method of the present invention.

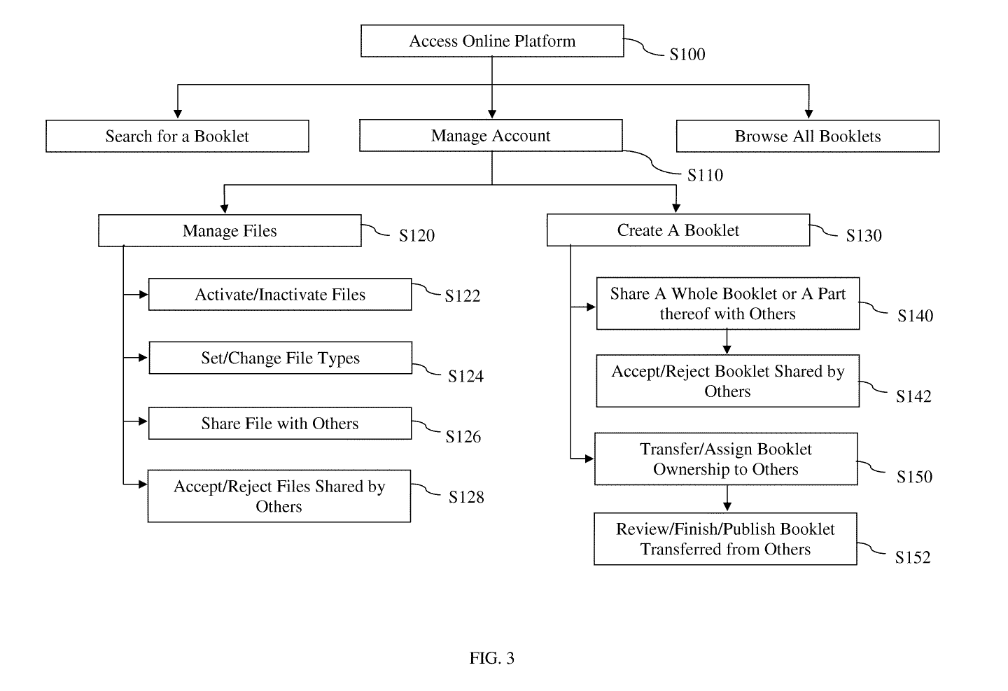

Referring to FIG. 3, there is shown a schematic illustration of an exemplary process for online management of contents and generation of booklets as parts of a computer-implemented method for generating and printing compilations of works in accordance with an embodiment of the present invention. Generally the steps shown in FIG. 3 reflect the steps that a compiler will take to manage the files and create booklets on the server that provides the online platform, e.g., server 2 shown in FIG. 1. Of course anyone who has the access to the server and authority to manage file folders assigned to him or her on the server can take these steps to manage his or her files on the server, not necessarily a complier.

As Step S100 shown in FIG. 3, the compiler accesses the online platform by, e.g., access the web-site of the online platform. The compiler typically needs to provide a valid username and a matching password to log in.

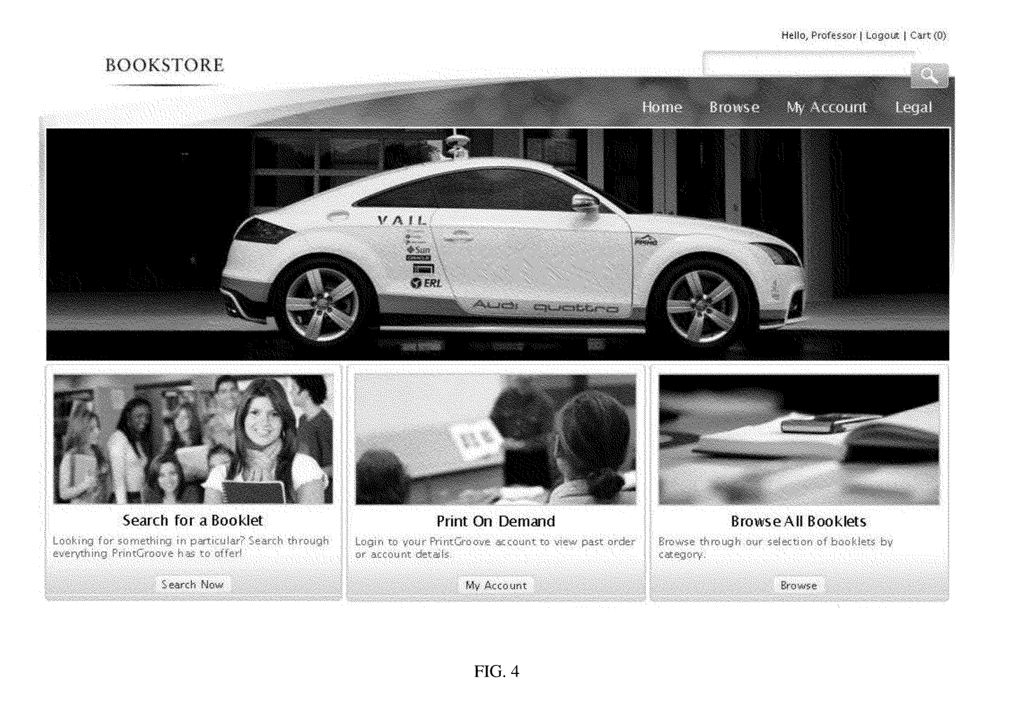

Referring to FIG. 4, there is shown a screen shot of an exemplary user interface (UI) display of the home page of the online platform web-site, in this example an online bookstore, after the compiler logs into the web-site. From this home page the compiler may search for a booklet by clicking on “Search Now” at the lower left portion of the screen, access his or her account by clicking on, e.g., “My Account” at either the top menu bar or the lower middle portion of the screen, or browse all booklets by clicking on, e.g., “Browse” at either the top menu bar or the lower right portion of the screen.

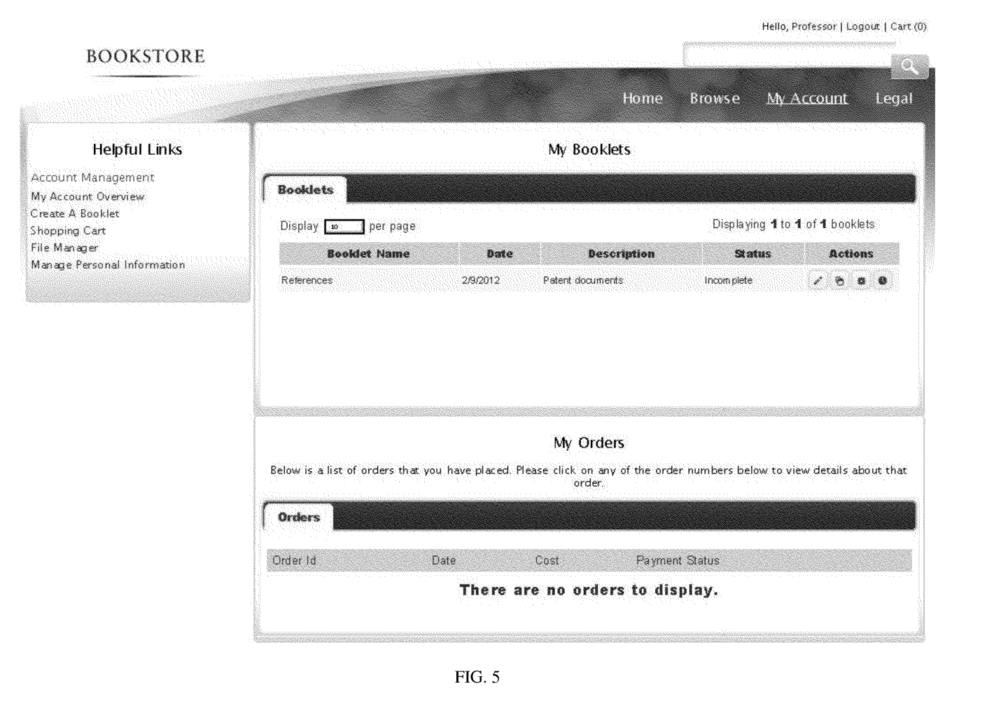

At Step S110 shown in FIG. 3, the compiler access his or her account by clicking on, e.g., “My Account” at either the top menu bar or the lower middle portion of the screen shown in FIG. 4. This will take the compiler to the “Account Overview” page as shown in FIG. 5.

Referring to FIG. 5, there is shown a screen shot of an exemplary UI display of the “Account Overview” page of the online platform web-site. On this page the compiler may see a list of the booklets that have been generated or are in progress, and also the status of all orders placed by the compiler. On the booklet list, each booklet is listed with its name, date of creation, its brief description, and its status. For example, a booklet in progress may be listed as “incomplete” (in progress), “ready” (generated but not activated for ordering), or “active” (activated for ordering). Under the “actions” menu heading at the end of the book list, there are icons for actions that may be taken on each of the booklet. For example, the action icons may include an icon for editing the booklet information, an icon for editing the booklet files, an icon for editing print options, and an icon for activating/deactivating the booklet.

On the left portion of the “Account Overview” page shown in FIG. 5, the compiler may click on the “File Manager” link to manage his or her files, or click on the “Create A Booklet” link to generate a booklet. The compiler may also click on the “Manage Personal Information” link to edit his or her personal information, or click on the “Shopping Cart” link to check out the items he or she intends to order.

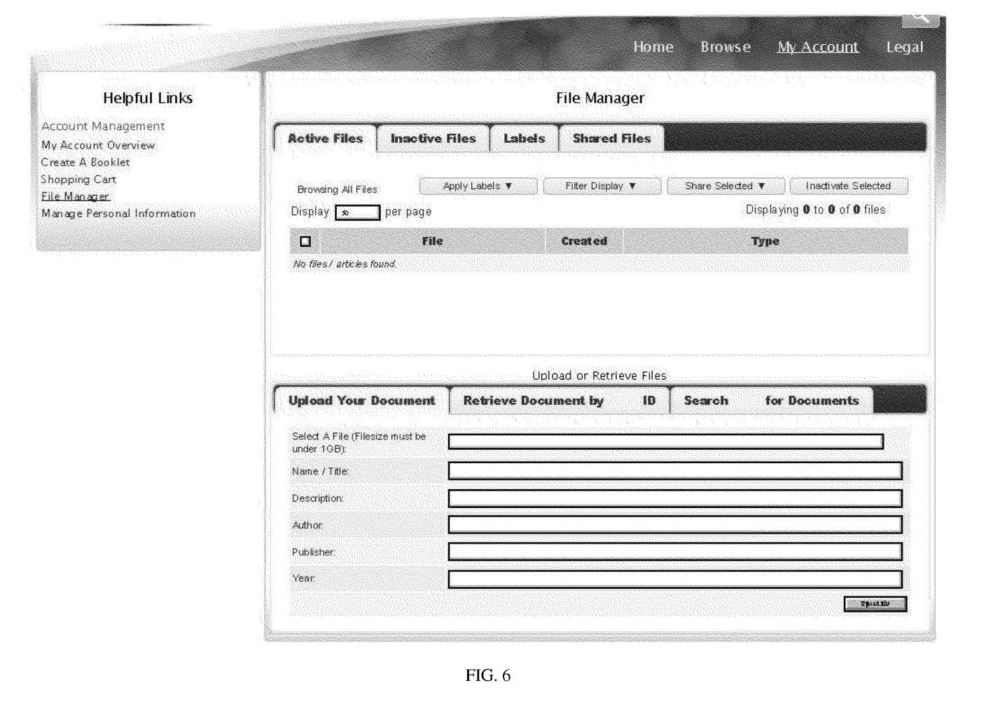

At Step S120 shown in FIG. 3, the compiler performs file management tasks by clicking on the “File Manager” link as shown in FIG. 5. This will take the compiler to the “File Manager” page of the online platform web-site as shown in FIG. 6.

Referring to FIG. 6, there is shown a screen shot of an exemplary UI display of the “File Manager” page of the online platform web-site. On this page the compiler may see a list of his or her files stored on the server, and upload or retrieve files. The main menu bar has buttons that allow the compiler to list “Active Files” that are made active (i.e., can be used in a booklet or shared), “Inactive Files” that remain inactive, “Labels” that are used to label the files, and “Shared Files” that are shared by other colleagues of the compiler.

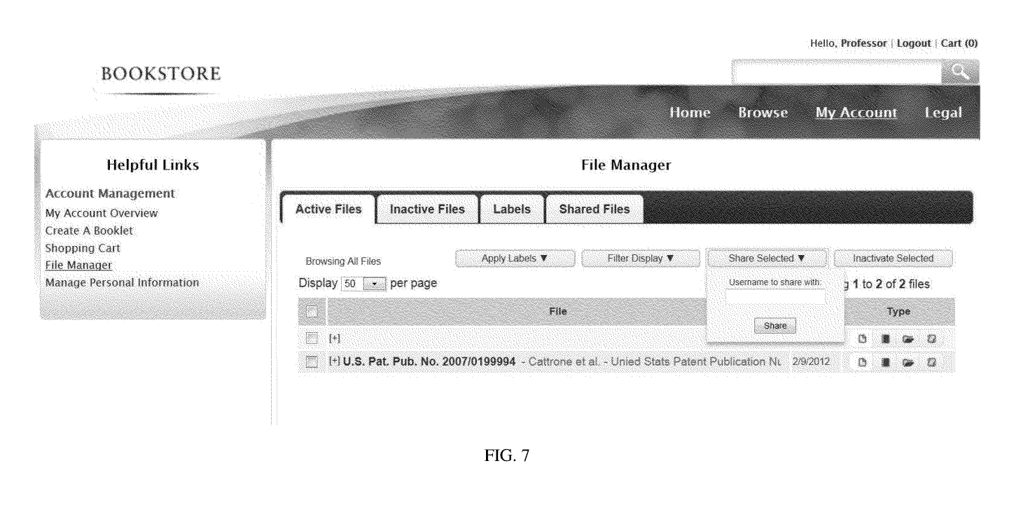

Referring to FIG. 7, there is shown a screen shot of an exemplary UI display of the “Active Files” page of the online platform web-site, upon which the active or activated files are listed. Using the supplemental menu bar under the main menu bar, the compiler may apply labels to the files, using filters to display files according to their labels, share selected files with the compiler's colleagues, and deactivate selected files.

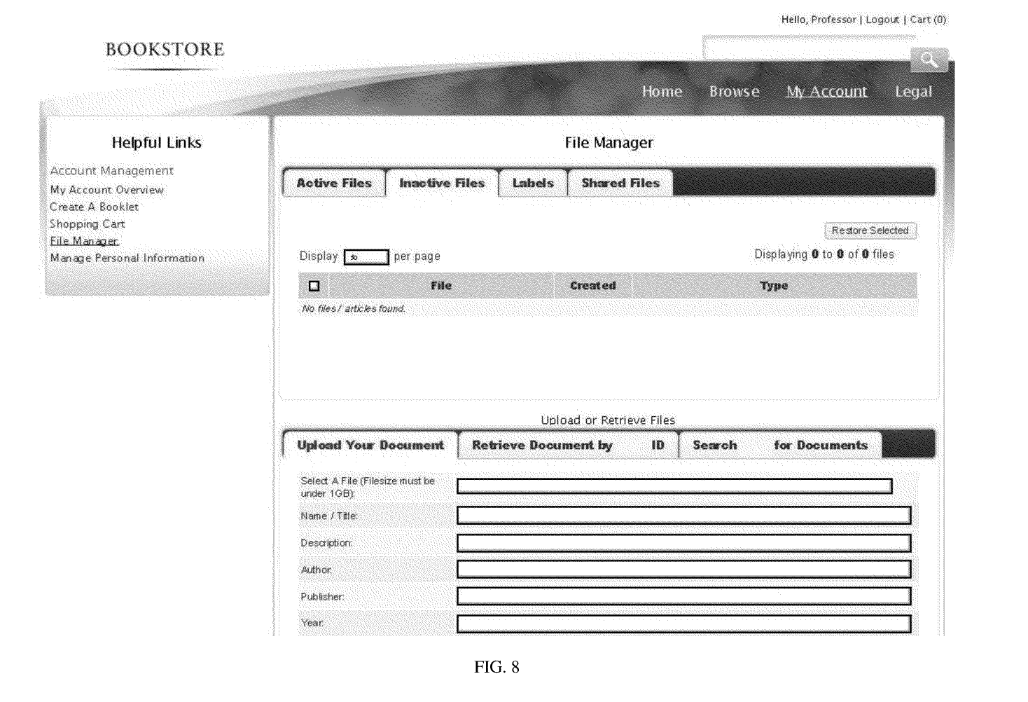

One or more files may be activated or deactivated by the compiler at Step 122 shown in FIG. 3. An active file may be deactivated by clicking on the small square box in front of its name and then clicking on the “Inactivate Selected” button. As mentioned above, active files may be the files that are or will be used in booklets or shared with others. Inactive files may be the files that are not used or to be used in any booklet. However, inactive files may not necessarily be deleted yet. A list of all inactive files may be viewed by clicking on the “Inactive Files” button on the top main menu of the “File Manager” page, as shown in FIG. 8.

Referring to FIG. 8, inactive files are listed in similar fashion as active files, and therefore not described in detail here to avoid redundancy. An inactive file may be restored back into an active file by first clicking on the small square box in front of the file name and then clicking on the “Restored Selected” button.

Referring back to FIG. 7, each file may be shown in a one-line view only with its name and the date of creation, or in an expanded view by clicking on a small plus sign icon in front of the file name. In the expanded view the small plus sign icon changes into a small minus sign icon. Clicking on the small minus sign icon will return back to the one-line view.

Particularly, at Step S124 shown in FIG. 3, the compiler may set and/or change file types to each of the active file listed, by clicking on the icons at the end of each file listed under the heading “Type” as shown in FIG. 7. These file type icons may include, for example, an icon for setting the file as a normal article, an icon for setting the file as a table of contents, an icon for setting the file as a cover page, and an icon for setting the file as a non-paginated file. The file types can be used when the file is used for generating a booklet to correctly position the file within the booklet. By clicking on one of these file type icons, the type of the file can be easily set or changed.

In addition, the compiler at Step S126 shown in FIG. 3 may share a selected file with one or more of his or her colleagues by first clicking on the small square box in front of the file name and then clicking on the “Share Selected” button in the supplement menu bar, upon which a small dialog box will be displayed as seen in FIG. 7 which allows the compiler to fill in the name of the colleague with whom the compiler desires to share the selected file. Sharing a selected file with a colleague will grant right to the colleague to view and use the file when the colleague creates his or her booklet.

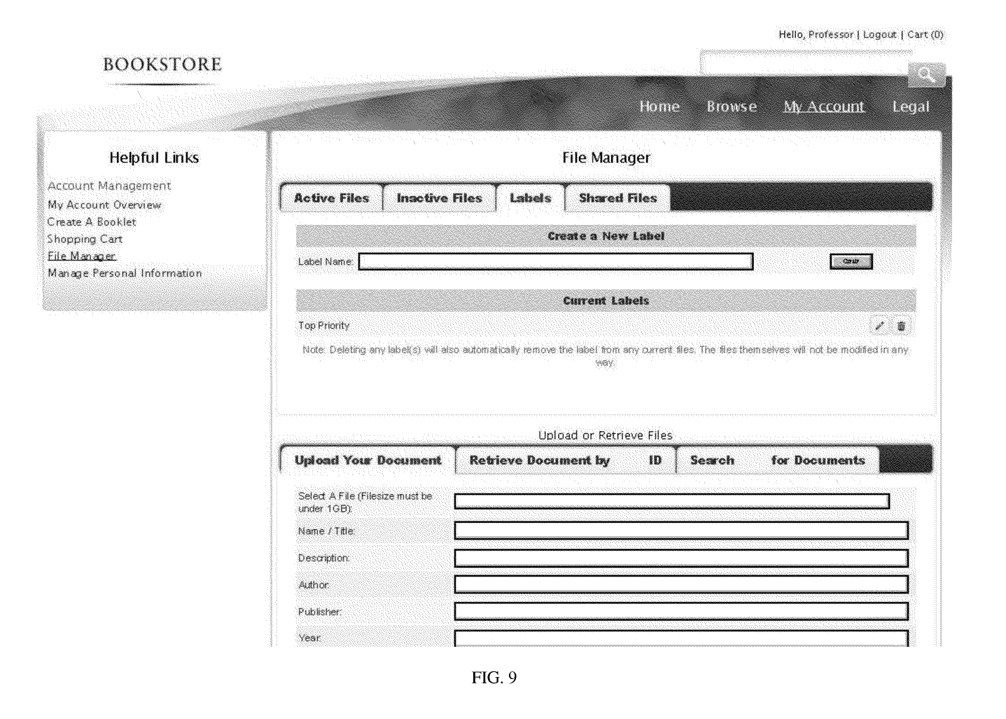

Referring to FIG. 9, labels may be viewed and managed by clicking on the “Labels” button in the top main menu of the “File Manager” page. Currently used labels, for example “Top Priority”, are listed. Each label may be edited or deleted by clicking on respective icons at the end of the label name. New labels may be created by typing in a new label name in a text box provided above the list of the labels.

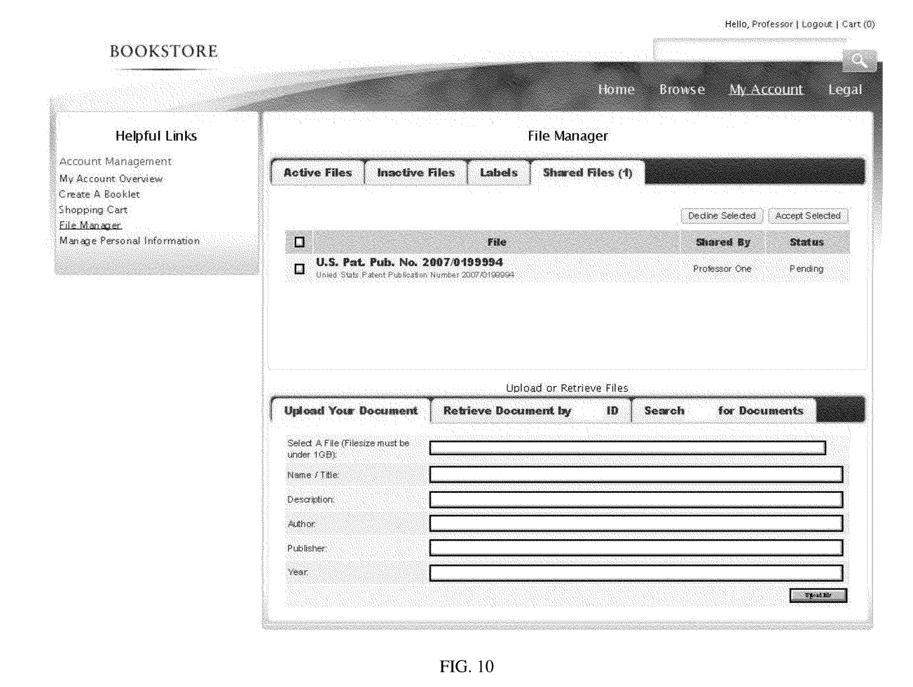

Moreover, the compiler at Step S128 shown in FIG. 3 can manage the files shared with him or her by his or her colleagues. By clicking on the “Shared File” button in the top main menu bar of the “File Manager” page, a page listing all filed shared by others will be displayed, as shown in FIG. 10.

Referring to FIG. 10, files that are shared by others are listed. It is noted that these are not the files that are shared by compiler with others. Rather, these are the files that are shared by others with the compiler. As the example in FIG. 10 shows, it is indicated under the heading “Shared By” that the file listed therein is shared by “professor two” who has shared this file with the compiler. The status of file is indicated under the heading “Status”. The compiler may click on the small square box in front of the name of a file listed to select it, and then either decline his or her colleague's offer of sharing the selected file with the compiler, or accept the offer. This can be done by clicking on the “Decline Selected” or “Accept Selected” button respectively. Before the compiler declines or accepts the offer of sharing a file by others, the status of the shared file is indicated as “pending”.

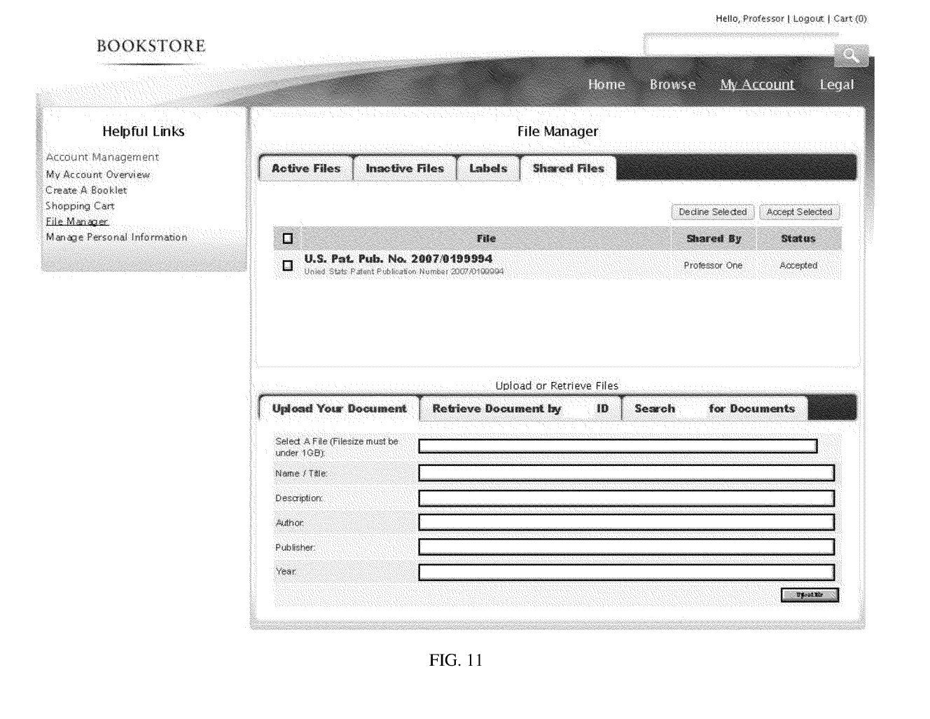

After the compiler declines or accepts the offer of sharing a file by others by first selecting the file and then clicking on the “Decline Selected” or “Accept Selected” button respectively, the status of the file will change to “Declined” or “Accepted” accordingly. For example, as shown in FIG. 11, after an offer of sharing a file is accepted, the status of the file is displayed as “accepted”. After the sharing of the file is accepted, the file can be used as his or her own file of the person who has accepted the offer of sharing.

A compiler's well managed file folder is in a sense like a small personal “library” of the compiler. The library contains articles with metadata that may be used to retrieve correct intellectual property (IP) rights such as copyrights. Some of the articles in the library may already have associate IP rights, e.g., the articles retrieved from a copyright management center database such as the SIPX database. Some of the articles on the library may not have IP right yet, e.g., the articles uploaded by the compiler. However, all necessary IP rights will be obtained by the online platform before the articles are used, e.g., printed in a booklet ordered and purchased by the readers. The files in the library are not necessarily purchased yet so they may not be downloaded or otherwise distributed, but the compiler can preview them in order to create booklets, and the IP rights of the booklets will be paid for later when the booklets are purchased.

Some of the articles in the library may have pricing information as well. The price of an article may be based on a number of factors, e.g. the number of pages, membership or affiliation of the compiler and/or the readers, etc. The metadata and other information of the articles may be sent to the copyright management center for calculating the price of the articles.

Since each compiler will be assigned a file folder, he or she will have his or her own “library”. However, compilers are able to share their files. This does not mean that they may download each other's shared file. Rather they have shared the information and access of the files at the online platform by sharing the files among them. Therefore shared files are not necessarily stored twice on the file server. If it is a file retrieved from the copyright management center database, then what is being shared among the compilers is merely a link to the file. However, if a compiler has uploaded his or her own version of a document and linked the uploaded version of the document to the metadata of the “original” document retrieved from the copyright management center database, then another compiler's library will only have the metadata linked to the original document as it stored in the copyright management center database, unless the compiler who has uploaded his or her own version of the document has shared the uploaded version with the other compiler.

Furthermore, if a compiler changes a file, e.g., rotates a page of a portable document format (PDF) file, then a PDF copy of the rotated page is created for this compiler only. Other compilers will still have the unchanged PDF version of the file in their library or when retrieving from the copyright management center database.

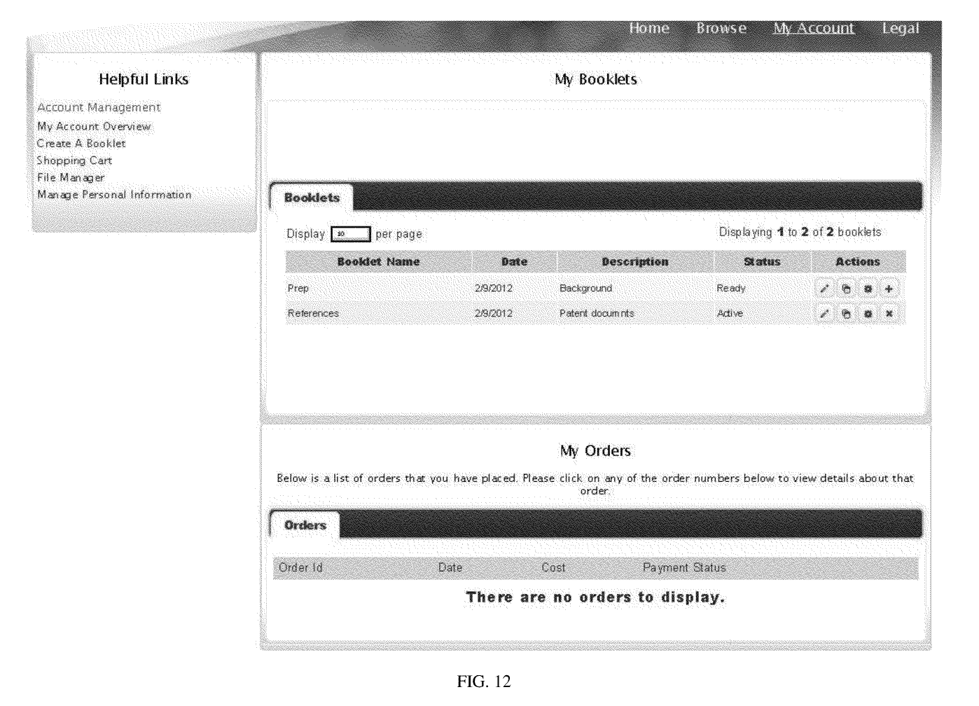

The feature of sharing articles is also applicable to a whole or part of a booklet that includes multiple articles. Referring to FIG. 12, there is shown a screen shot of an exemplary UI display of the “My Account Overview” page of the online platform web-site, showing the booklet that has just been created and saved at Step S130 shown in FIG. 3.

After a booklet is created, the compiler of the booklet may desire to share the entire booklet or part of it with others. This is the “Share A Whole Booklet or A Part thereof with Others” Step S140 shown in FIG. 3, which may be handled in a similar fashion as the sharing of the articles as described above. The person to whom the whole or part of a booklet is shared with will also have a choice of accepting or rejecting the sharing of the booklet. This is the “Accept/Reject Booklet Shared by Others” Step S142 shown in FIG. 3.

Sometimes the compiler may desire to transfer or assign the booklet to another person. This may happen, for example, when a teacher or instructor has asked other people such as a teaching assistant to help him or her in preparation of a booklet and after the booklet is prepared, the teacher or instructor needs to have full control or capacity in revising, finishing and/or publishing the booklet. Another example may be that a teacher no longer needs to use the booklet but another teacher may need to use the booklet. In any event the embodiments of present invention methods provide that a whole or a part of a booklet may be transferred or assigned. This is the “Transfer/Assign Booklet Ownership to Others” Step S150 shown in FIG. 3. The person to whom the whole or part of a booklet is transferred to may have a choice of accepting or rejecting the transfer of the booklet. Once a booklet is transferred, the person to whom the booklet is transferred to will have full right and control over the booklet, such that he or she may review, finalize publish the booklet. This is the “Review/Finish/Publish Booklet Transferred from Others” Step S152 shown in FIG. 3. It is noted that the assignment or transfer of a booklet results in a change of ownership to the booklet. It is also noted that transfer of partial ownership right or transfer some of the rights but not all of the rights in a booklet is also possible. This means that an owner of a booklet may assign partial right or transfer some of the rights to others. For example, the right to use or print a booklet may be transferred without the right to modify or change the booklet.

When a booklet is shared or transferred, its structure is shared or transferred together with its content files. For example, if a cover or a table of contents is created and the sequence of the pages are arranged for the booklet, they will all be shared or transferred with the content articles of the booklet.

The above described process may be implemented by a computer software program. The present invention also provides a computer program product that includes a computer usable non-transitory medium (e.g. memory or storage device) having a computer readable program code embedded therein for controlling a data processing apparatus, the computer readable program code configured to cause the data processing apparatus to execute the above described process.

It will be apparent to those skilled in the art that various modification and variations can be made in the method and related apparatus of the present invention without departing from the spirit or scope of the invention. Thus, it is intended that the present invention cover modifications and variations that come within the scope of the appended claims and their equivalents.

What is claimed is:

1. A method for managing files for producing a compilation of works, comprising the steps of:
obtaining a file of a work to be compiled in a booklet by a first user;
sharing the file by the first user with a second user; and
selecting by the second user to accept or reject the sharing of the file shared by the first user.

2. The method of claim 1, wherein the step of obtaining a file further comprises obtaining metadata of the file.

3. The method of claim 2, wherein the step of sharing the file further comprises sharing metadata of the file.

4. The method of claim 1, wherein the step of obtaining a file further comprises obtaining information of the file that can be used to locate the file in a database.

5. The method of claim 4, wherein the step of sharing the file further comprises sharing information of the file that can be used to locate the file in a database.

6. A method for managing files for producing a compilation of works, comprising the steps of:
creating a booklet by a first user that contains files of works to be compiled;
sharing a part or whole of the booklet by the first user with a second user; and
selecting by the second user to accept or reject the sharing of the booklet shared by the first user.

7. The method of claim 6, wherein the step of creating a booklet further comprises creating a booklet structure.

8. The method of claim 7, wherein the step of sharing the booklet further comprises sharing the booklet structure.

9. A method for managing files for producing a compilation of works, comprising the steps of:
creating a booklet by a first user that contains files of works to be compiled;
transferring the booklet from the first user to a second user; and
selecting by the second user to accept or reject the transfer of the booklet by the first user.

10. The method of claim 9, wherein the step of transferring the booklet further comprises transferring some or all of the rights to the booklet.

11. A computer program product comprising a non-transitory computer usable medium having a computer readable code embodied therein for controlling a data processing apparatus, the computer readable program code configured to cause the data processing apparatus to execute a process for managing files for producing a compilation of works, the process comprising the steps of:
obtaining a file of a work to be compiled in a booklet by a first user;
sharing the file by the first user with a second user; and
selecting by the second user to accept or reject the sharing of the file shared by the first user.

12. The computer program product of claim 11, wherein the step of obtaining a file further comprises obtaining metadata of the file.

13. The computer program product of claim 12, wherein the step of sharing the file further comprises sharing metadata of the file.

14. The computer program product of claim 11, wherein the step of obtaining a file further comprises obtaining information of the file that can be used to locate the file in a database.

15. The computer program product of claim 14, wherein the step of sharing the file further comprises sharing information of the file that can be used to locate the file in a database.

16. A computer program product comprising a non-transitory computer usable medium having a computer readable code embodied therein for controlling a data processing apparatus, the computer readable program code configured to cause the data processing apparatus to execute a process for managing files for producing a compilation of works, the process comprising the steps of:
creating a booklet by a first user that contains files of works to be compiled;
sharing a part or whole of the booklet by the first user with a second user; and
selecting by the second user to accept or reject the sharing of the booklet shared by the first user.

17. The computer program product of claim 16, wherein the step of creating a booklet further comprises creating a booklet structure.

18. The computer program product of claim 17, wherein the step of sharing the booklet further comprises sharing the booklet structure.

19. A computer program product comprising a non-transitory computer usable medium having a computer readable code embodied therein for controlling a data processing apparatus, the computer readable program code configured to cause the data processing apparatus to execute a process for managing files for producing a compilation of works, the process comprising the steps of:
creating a booklet by a first user that contains files of works to be compiled;
transferring the booklet from the first user to a second user; and
selecting by the second user to accept or reject the transfer of the booklet by the first user.

20. The computer program product of claim 19, wherein the step of transferring the booklet further comprises transferring some or all of the rights to the booklet.
